(19) United States
(12) Patent Application Publication
(10) Pub. No.: US 2015/0168557 A1
(43) Pub. Date: Jun. 18, 2015

(54) METHOD AND A RECEIVER FOR SATELLITE POSITIONING

(71) Applicant: O2Micro, Inc., Santa Clara, CA (US)

(72) Inventors: Jinghua ZOU, Chengdu (CN); Juan GOU, Chengdu (CN); Jun CHEN, Chengdu (CN); James WANG, San Jose, CA (US)

(73) Assignee: O2Micro, Inc., Santa Clara, CA (US)

(21) Appl. No.: 14/132,320

(22) Filed: Dec. 18, 2013

(51) Int. Cl. G01S 19/05

(52) U.S. Cl. CPC G01S 19/05

(57) ABSTRACT

A method and a receiver for satellite positioning are disclosed. The method comprises determining first quality of a first signal associated with a Satellite Based Augmentation System (SBAS) and second quality of a second signal associated with one or more other navigation systems. The method also comprises calculating a position of the receiver by combining a first estimated position from the SBAS and a second estimated position from the one or more other navigation systems in a manner determined based on the first quality and the second quality.

### BACKGROUND

At present, there are four sets of satellite navigation systems in the world: Global Positioning System (GPS), Global Navigation Satellite System (GLONASS) satellite navigation system, BeiDou (Compass) satellite navigation system, and Galileo satellite navigation system, developed by United States, Russia, China, and Europe, respectively. Those navigation systems will not perform well in some regions where satellite signal is very weak, e.g., urban or canyons. In those regions, there are very few visible satellites, thus increasing the navigation error. To be worse, if navigation signals of these navigation systems are blocked completely, the performance of a navigation receiver will deteriorate sharply such that the navigation receiver can stop working.

Therefore, there is a need for a method and a receiver for satellite positioning, to avoid the above drawbacks and improve navigation accuracy in regions with weak satellite signals.

### SUMMARY

In one embodiment, a method for satellite positioning is disclosed. The method comprises determining first quality of a first signal associated with a Satellite Based Augmentation System (SBAS) and second quality of a second signal associated with one or more navigation systems. The method also comprises calculating a position of a receiver by combining a first estimated position from the SBAS and a second estimated position from the one or more navigation systems in a manner determined based on the first quality and the second quality.

In another embodiment, a receiver is disclosed. The receiver comprises a detection module and a calculation module. The detection module is configured for determining first quality of a first signal associated with a Satellite Based Augmentation System (SBAS) and second quality of a second signal associated with one or more positioning navigation systems. The calculation module is configured for calculating a position of the receiver by combining a first estimated position from the SBAS and a second estimated position from the one or more positioning navigation systems in a manner determined based on the first quality and the second quality.

### BRIEF DESCRIPTION OF THE DRAWINGS

The disclosure will be readily understood in view of the following description when accompanied by the below figures and wherein like reference numerals represent like elements, wherein:

FIG. 1 shows a model diagram illustrating an example of a navigation system for positioning and velocity calculating, in accordance with one embodiment of the present teaching;

FIG. 2 shows an observation vector from a navigation receiver to a satellite, in accordance with one embodiment of the present teaching;

FIG. 3 shows a flowchart illustrating a method for satellite positioning, in accordance with one embodiment of the present teaching;

FIG. 4 shows a flowchart illustrating a method for satellite positioning, in accordance with another embodiment of the present teaching;

FIG. 5 shows a flowchart illustrating a method for satellite positioning, in accordance with still another embodiment of the present teaching;

FIG. 6 shows a flowchart illustrating a method for satellite positioning, in accordance with yet another embodiment of the present teaching;

FIG. 7 shows a flowchart illustrating a method for satellite positioning, in accordance with yet another embodiment of the present teaching;

FIG. 8 shows a block diagram illustrating an example of a structure of a navigation receiver, in accordance with one embodiment of the present teaching.

### DETAILED DESCRIPTION

Reference will now be made in detail to the embodiments of the present teaching, examples of which are illustrated in the accompanying drawings. While the present teaching will be described in conjunction with the embodiments, it will be understood that they are not intended to limit the present teaching to these embodiments. On the contrary, the present teaching is intended to cover alternatives, modifications, and equivalents, which may be included within the spirit and scope of the present teaching as defined by the appended claims.

Furthermore, in the following detailed description of embodiments of the present teaching, numerous specific details are set forth in order to provide a thorough understanding of the present teaching. However, it will be recognized by one of ordinary skill in the art that the present teaching may be practiced without these specific details. In other instances, well-known methods, procedures, components, and circuits have not been described in detail as not to unnecessarily obscure aspects of the embodiments of the present teaching.

The positioning performance based on the Global Navigation Satellite System (GNSS) is good when there are many visible satellites. However, if there are few visible satellites or if the visible satellites have a geometric configuration of poor quality, the positioning performance based on satellites is poor or unstable. This is because the geometric configuration of the satellites will not change when positioning based merely on the navigation satellites. Thus, the positioning accuracy cannot be improved. Therefore, the present teaching discloses a positioning method for positioning in regions with weak satellite signals, based on both satellites of the Satellite Based Augmentation System (SBAS) and satellites of the GNSS, to improve the positioning accuracy.

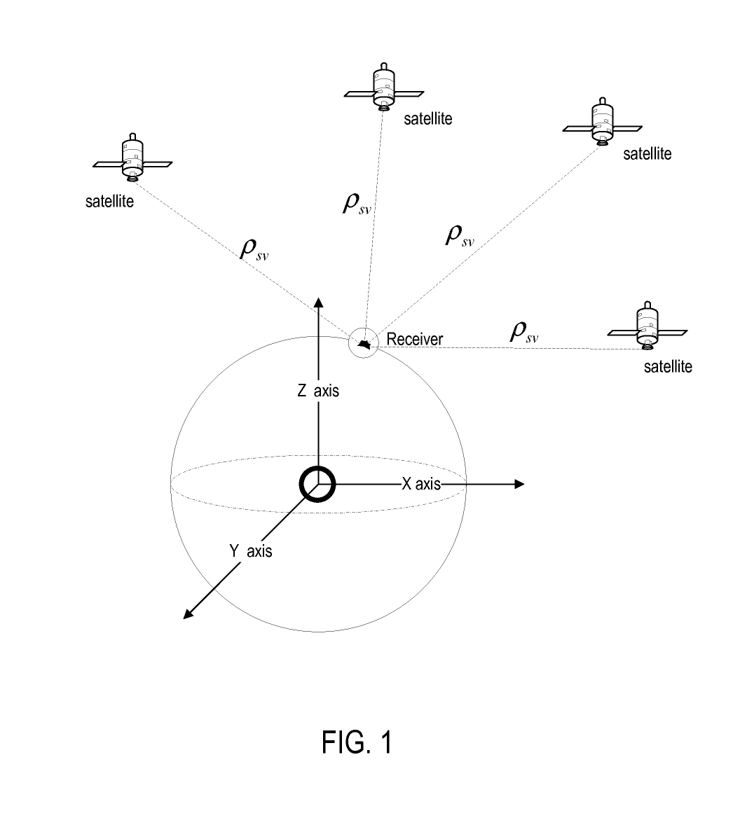

FIG. 1 shows a model diagram illustrating an example of a navigation system for positioning and velocity calculating, in accordance with one embodiment of the present teaching. In FIG. 1, the ρₛᵥ represents the distance between a satellite and a receiver.

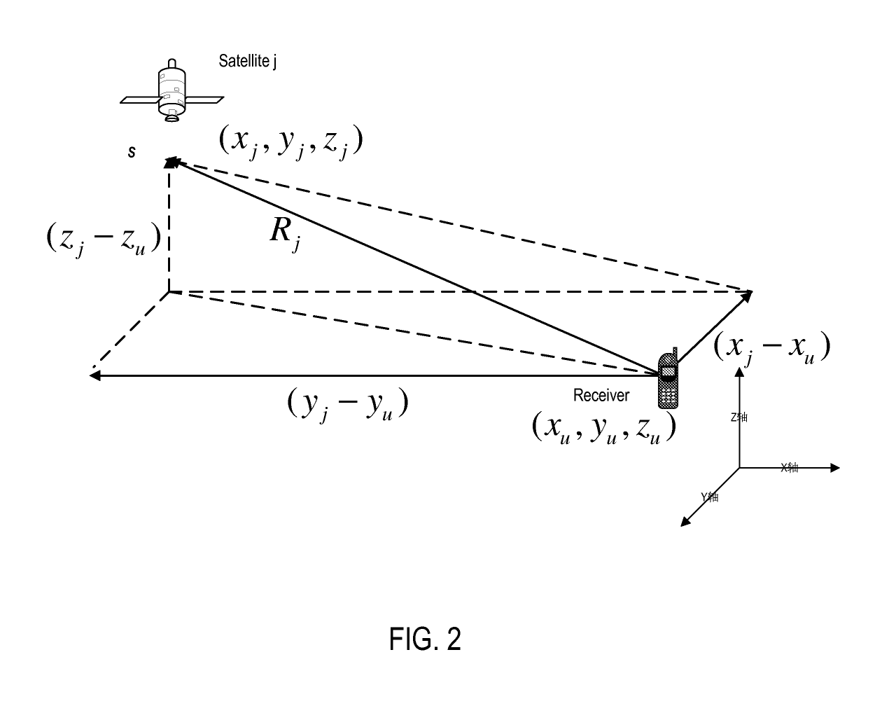

The principles of positioning and velocity calculating based on a navigation system will be described in view of FIG. 2, which shows an observation vector from a navigation receiver to a satellite, in accordance with one embodiment of the present teaching.

1. The positioning principle based on a single navigation system.

As shown in FIG. 2, the coordinate position of a receiver, e.g., the GPS receiver, in the Earth-Centered Earth-Fixed (ECEF) coordinate system is set as U (xᵤ, yᵤ, zᵤ) and the coordinate position of the satellite j is Sᵢ (xᵢ, yᵢ, zᵢ). Then an observation equation of a corrected pseudo-range is given as equation (1):

ρⱼ=∥Sⱼ−U∥+ctᵤ (1)

wherein, j=1, 2, . . . . , N, and j is a temporary number of a currently effective satellite, rather than the SVN (Satellite Vehicle Number) number or PRN (Pseudo-Random Noise) number of the satellites; ∥S₁−U∥ represents the geometric distance between the receiver and the satellite j, which can be given as equation (2) below; c represents the velocity of light; tᵤ represents a clock bias of the receiver; ρⱼ represents the pseudo-range after an error correction (EC) that is measured by the receiver.

Rⱼ==∥Sⱼ−U∥=\sqrt{(xⱼ−xᵤ)²+(yⱼ−yᵤ)²+(zⱼ−zᵤ)²} (2)

According to the equations (1) and (2), a non-linear equation (3) as following can be established to calculate the coordinate of the position (xᵤ, yᵤ, zᵤ) and the clock bias tᵤ of the receiver.

$$\{ \begin{matrix}{ρ}_{1} = \sqrt{{( {x}_{1} - {x}_{u} )}^{2} + {( {y}_{1} - {y}_{u} )}^{2} + {( {z}_{1} - {z}_{u} )}^{2}} + {ct}_{u} \\ {ρ}_{2} = \sqrt{{( {x}_{2} - {x}_{u} )}^{2} + {( {y}_{2} - {y}_{u} )}^{2} + {( {z}_{2} - {z}_{u} )}^{2}} + {ct}_{u} \\ ⋯ \\ {ρ}_{N} = \sqrt{{( {x}_{N} - {x}_{u} )}^{2} + {( {y}_{N} - {y}_{u} )}^{2} + {( {z}_{N} - {z}_{u} )}^{2}} + {ct}_{u}\end{matrix} \qquad ( 3 )$$

2. The velocity calculating principle based on a signal navigation system.

The velocity is estimated based on the Doppler frequency received by the receiver. The Doppler shift on a signal received by the receiver is due to a relative movement between the satellites and the receiver. The frequency f_{R} of the signal received by the receiver can be calculated according to equation (4) as following:

$${f}_{R} = {f}_{T} ( 1 - \frac{( V - \dot{u} ) A}{c} ) \qquad ( 4 )$$

where, f_{T} represents a frequency of a carrier signal transmitted by a satellite; V represents a velocity vector of the satellite; \dot{u} represents a velocity vector of the receiver; A represents a unit vector with the direction from the receiver to the satellite; and c represents the velocity of light.

For the jth satellite, the equation (4) can be described as equation (5):

$$\begin{matrix}{f}_{Rj} = {f}_{Tj} \{ 1 - \frac{1}{c} [ ( {V}_{j} - \dot{u} ) \cdot {A}_{j} ] \} & ( 5 ) \\ where , {V}_{j} = ( {v}_{xj} , {v}_{yj} , {v}_{zj} ) & ( 5 \text{-} 1 ) \\ {A}_{j} = ( {a}_{xj} , {a}_{yj} , {a}_{zj} ) & ( 5 \text{-} 2 ) \\ \dot{u} = ( {\dot{x}}_{u} , {\dot{y}}_{u} , {\dot{z}}_{u} ) & ( 5 \text{-} 3 ) \\ {a}_{xj} = \frac{{x}_{j} - {x}_{u}}{{R}_{j}} & ( 5 \text{-} 4 ) \\ {a}_{yj} = \frac{{y}_{j} - {y}_{u}}{{R}_{j}} & ( 5 \text{-} 5 ) \\ {a}_{zj} = \frac{{z}_{j} - {z}_{u}}{{R}_{j}} & ( 5 \text{-} 6 )\end{matrix}$$

For the jth satellite, the measurement estimation for the frequency of the received signal is fⱼ. The measurement estimation has errors, and also has one frequency shift from f_{Rj}. The frequency shift is correlated with the time shift \dot{t}ᵤ of the clock in the receiver relative to the navigation system time, e.g., the GPS system time. The unit of the time shift \dot{t}ᵤ is second/second. The relationship of fⱼ with f_{Rj} can be shown in equation (6):

f_{Rj}=fᵢ(1+\dot{t}ᵤ) (6)

Combining the equations (5) and (6), and after an algebraic process, an equation (7) can be obtained as following:

$$\frac{c ( {f}_{j} - {f}_{Tj} )}{{f}_{Tj}} + {V}_{j} \cdot {A}_{j} = \dot{u} \cdot {A}_{j} - \frac{{cf}_{j} {\dot{t}}_{u}}{{f}_{Tj}} \qquad ( 7 )$$

By a vector component expansion on the dot product vector, an equation (8) is obtained as following:

$$\frac{c ( {f}_{j} - {f}_{Tj} )}{{f}_{Tj}} + {v}_{xj} {a}_{xj} + {v}_{yj} {a}_{yj} + {v}_{zj} {a}_{zj} = {\dot{x}}_{u} {a}_{xj} + {\dot{y}}_{u} {a}_{yj} + {\dot{z}}_{u} {a}_{zj} - \frac{{cf}_{j} {\dot{t}}_{u}}{{f}_{{T}_{j}}} \qquad ( 8 )$$

The left side of the equation (8) is set as following:

$${d}_{j} = \frac{c ( {f}_{j} - {f}_{Tj} )}{{f}_{Tj}} + {v}_{xj} {a}_{xj} + {v}_{yj} {a}_{yj} + {v}_{zj} {a}_{zj} \qquad ( 9 )$$

The value of

$$\frac{{f}_{j}}{{f}_{Tj}}$$

is very close to 1. In an ordinary example the difference between

$$\frac{{f}_{j}}{{f}_{Tj}}$$

and 1 may be a few parts per million. Thus, the equation (8) can be simplified as following:

dᵢ=\dot{x}ᵤaₓⱼ+\dot{y}ᵤa_{yj}+żᵤa_{zj}c\dot{t}ᵤ (10)

A set of 4-variable equations are established for the variable \dot{u}=\dot{x}ᵤ,\dot{y}ᵤ,żᵤ,\dot{t}ᵤ as following:

d=Hg (11)

wherein,

$$\begin{matrix}d = [ \begin{matrix}{d}_{1} \\ {d}_{2} \\ ⋯ \\ {d}_{N}\end{matrix} ] & ( 11 \text{-} 1 ) \\ H = [ \begin{matrix}{a}_{x 1} & {a}_{y 1} & {a}_{z 1} & 1 \\ {a}_{x 2} & {a}_{y 2} & {a}_{z 2} & 1 \\ ⋯ & ⋯ & ⋯ & 1 \\ {a}_{x N} & {a}_{y N} & {a}_{z N} & 1\end{matrix} ] & ( 11 \text{-} 2 ) \\ g = [ \begin{matrix}{\dot{x}}_{u} \\ {\dot{y}}_{u} \\ {\dot{z}}_{u} \\ - c {\dot{t}}_{u}\end{matrix} ] & ( 11 \text{-} 3 )\end{matrix}$$

Accordingly, the velocity and the time shift can be obtained as following by equation (12):

g=H⁻¹d (12)

wherein, H⁻¹ represents an inverse matrix of the matrix H.

3. The positioning principle of multiple navigation systems.

The model diagram of multiple navigation systems for positioning is also shown as FIG. 1. But the multiple navigation systems have different clock references from each other, thus there is a clock bias between two different navigation systems. Therefore, the number of the clock biases tᵤ between the receiver and the navigation systems can be M, wherein M represents the number of the navigation systems. For the ith satellite navigation system, a set of 4-variable non-linear equations for calculating the coordinate position (xᵤ, yᵤ, zᵤ) of the receiver and the clock bias tᵤ of the receiver are given by equation (13):

$$\{ \begin{matrix}{ρ}_{1} = \sqrt{{( {x}_{1} - {x}_{u} )}^{2} + {( {y}_{1} - {y}_{u} )}^{2} + {( {z}_{1} - {z}_{u} )}^{2}} + {ct}_{ui} \\ {ρ}_{2} = \sqrt{{( {x}_{2} - {x}_{u} )}^{2} + {( {y}_{2} - {y}_{u} )}^{2} + {( {z}_{2} - {z}_{u} )}^{2}} + {ct}_{ui} \\ ⋯ \\ {ρ}_{N} = \sqrt{{( {x}_{N} - {x}_{u} )}^{2} + {( {y}_{N} - {y}_{u} )}^{2} + {( {z}_{N} - {z}_{u} )}^{2}} + {ct}_{ui}\end{matrix} \qquad ( 13 )$$

In equation (13), these 1˜N satellites are from the same navigation system.

If there are multiple satellites coming from multiple navigation systems, the equation is given as equation (14):

ρᵢⱼ=\sqrt{(xᵢⱼ−xᵤ)²+(yᵢⱼ−yᵤ)²+(zᵢⱼ−zᵤ)²}+c·tᵤᵢ (14)

wherein, ρᵢⱼ represents a pseudo-range of the jth satellite in the ith satellite navigation system; tᵤᵢ represents a clock bias of the receiver relative to ith navigation system; (xᵢⱼ, yᵢⱼ, zᵢⱼ) represents a position coordinate of the jth satellite in the ith satellite navigation system; and (xᵤ, yᵤ, zᵤ) represents a position coordinate of the receiver.

For M navigation systems, the number of the sets of equations similar to equations (13) is M. In such a situation, the number of unknowns is changed from 4, i.e., Xᵤ, yᵤ, Zᵤ, tᵤ in single navigation system, to (3+M) unknowns, i.e., Xᵤ, yᵤ, Zᵤ, tᵤ₁, tᵤ₂ . . . t_{uM}, in M navigation systems. The coordinate position of the receiver and the clock bias between the receiver and the navigation system can be calculated by the M equations (13). In this way, the positioning and the time bias between the receiver and the navigation systems can be obtained for positioning and time bias related service.

Positioning based on multiple navigation systems can increase the number of the positioning satellites greatly by increasing only a few unknowns. In this way, the Dilution of Precision (DOP) is reduced, and the positioning accuracy is also improved by increasing the number of satellites to achieve little error.

4. The velocity calculating principle of multiple navigation systems.

As described in the single navigation system, the receiver needs to get the received satellite frequency, the frequency of the carrier signal, the velocity of the satellite, the position coordinate of the satellite and the position coordinate of the receiver before velocity calculating. The frequency of the carrier signal is known, and other information can be obtained by measuring or position calculation. The unknowns include xᵤ^{&},yᵤ^{&},zᵤ^{&},tᵤ^{&}, wherein \dot{t}ᵤ represents the time shift of the receiver's system time, which depends on characteristic of the receiver's system and does not depend on the navigation systems. Thus, the equation for velocity calculating based on multiple navigation systems is the same as that based on a single navigation system. In other words, in multiple navigation system, the receiver calculates the velocity by increasing the number of the navigation satellites without increasing the number of unknowns, thus the accuracy of velocity calculation can be greatly increased.

The principle of positioning and velocity calculating by using SBAS will be described as following.

5. SBAS for positioning.

The SBAS satellites are located on the Geostationary Earth Orbit (GEO), and are mainly used for correcting the error of the orbital parameter and the estimation of the Ionospheric model. Currently, the global SBAS include: EGNOS (European Geostationary Navigation Overlay Service) for covering the European Continent, DGPS (Differential Global Positioning System) and WAAS (Wide Area Augmentation System) of America for covering the America Continent, MSAS (Multi-functional Satellite Augmentation System) of Japan for covering the Asia Continent, and GAGAN (GPS-aided geo-augmented navigation) of India.

All of these SBAS have their own system clocks. That is, clock bias exists between two different SBAS. Thus, one kind of SBAS can act as an independent navigation system when positioning, for example, when calculating position according to the above equation (14).

The receiver in most places can receive signals from just 1 to 2 SBAS satellites since SBAS satellites are operable for region-covering by the main controlling terminals. However, according to the above equation (14) that is used for calculating position based on multiple navigation systems, when one more navigation system is added, one more unknown tᵤᵢ is added accordingly, wherein the unknown tᵤᵢ represents the clock bias of the receiver relative to this navigation system. Thus, a navigation system having many satellites is usually chosen for position calculation, to reduce computational complexity.

Further, if the clock bias of a SBAS relative to a navigation system A is known, a pseudo-range of a SBAS satellite can be corrected to the pseudo-range of a satellite of navigation system A based on the known clock bias. Thus, the SBAS satellite can be treated as a satellite of the navigation system A for positioning, and accordingly, the number of unknowns for position calculation is reduced and the positioning accuracy is improved.

Moreover, a clock bias of each SBAS relative to the GPS is less than 50 ns, so that the errors due to the clock bias between the SBAS and GPS can be neglected in some weak signal areas. For example, in some areas in which a pseudo-range errors of satellites in a navigation system are much greater than 50 ns (corresponding to about 15 m), the errors due to the clock bias can be neglected compared to the pseudo-range errors. As such, a SBAS satellite can be taken as a satellite of GPS for calculating position,

6. SBAS satellite for velocity calculating.

As described above, the unknowns of velocity calculating are the velocity of receiver and the time shift of the receiver's system time, which depend on the characteristic of the receiver's system and do not depend on the navigation systems. Thus, all kinds of SBAS satellites can be used for velocity calculating, without increasing the number of unknowns,

As described above, even though a SBAS satellite is different from a satellite of a specific navigation system, the SBAS satellite can also be used for positioning and velocity calculating. As such, the present teaching discloses a method and a receiver for satellite positioning based on both the SBAS satellites and the satellites of other navigation systems. Various embodiments of the present teaching are described in the following.

### Embodiment 1

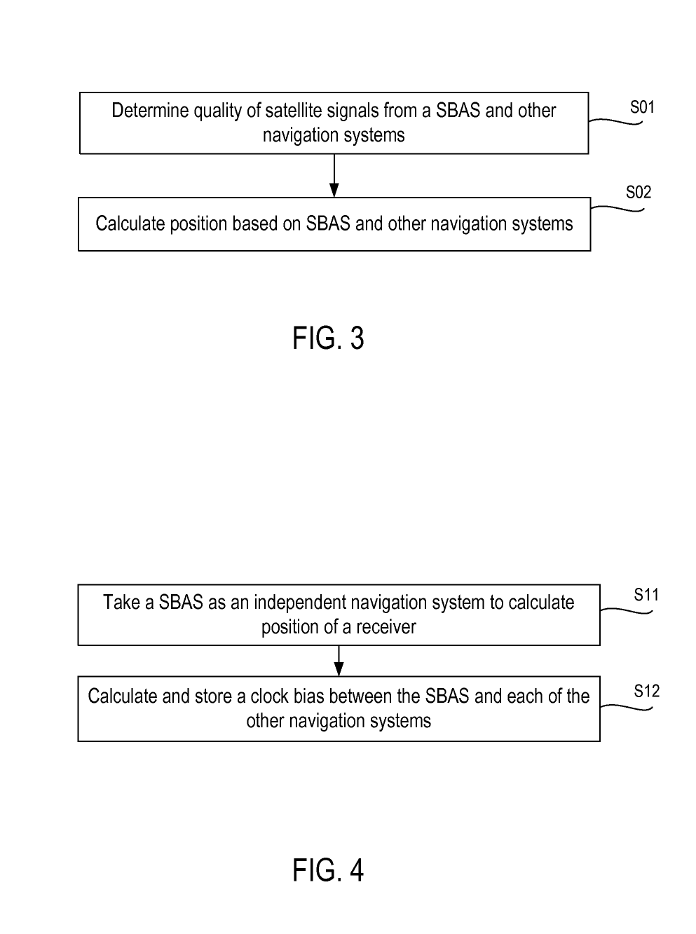

In one embodiment, FIG. 3 shows a flowchart illustrating a method for satellite positioning. The specific navigation systems other than the SBAS will be referred as other navigation systems. In this embodiment, quality of the satellite signals from both SBAS and other navigation systems can be estimated and determined by three levels: good, medium, and bad.

The quality of satellite signals may be estimated according to many factors, for example, the number of satellites, the satellite elevation angle, the tracking quality, DOP and so on. As shown in FIG. 3, the method for satellite positioning in the present teaching includes the following.

At S01, quality of the satellite signals from a SBAS and other navigation systems is determined.

At S02, position of a receiver is calculated based on the SBAS and other navigation systems. This may happen when the quality of satellite signals from other navigation systems is not better than that of satellite signals from the SBAS.

For example, in one embodiment, when the quality of satellite signals from a SBAS is good or medium, and the quality of satellite signals from at least one of the other navigation systems is good or medium, the SBAS can be used as an independent navigation system to be utilized together with other navigation systems to calculate position according to equation (14).

In another embodiment, if the quality of satellite signals from one navigation system (i.e., navigation system B) is medium or even bad, and a clock bias of a SBAS relative to the navigation system B has been stored in the receiver, a pseudo-range of a SBAS satellite can be corrected based on this stored clock bias, Thus, according to the corrected pseudo-range, the SBAS satellite can be treated as a satellite of the navigation system B to calculate position based on equation (14).

In still another embodiment, if the quality of satellite signals from one navigation system (i.e., navigation system C) is bad, and a clock bias of a SBAS relative to the navigation system C has not been stored in the receiver, a SBAS satellite can be taken as a GPS satellite for calculating position based on equation (14) directly since the clock bias of SBAS relative to GPS is less than 50 ns and can be neglected.

### Embodiment 2

FIG. 4 shows a flowchart illustrating a method for satellite positioning, in accordance with another embodiment of the present teaching. In this embodiment, the satellite signals from both SBAS and other navigation systems have good quality. As shown in FIG. 4, this method includes the following.

At S11, a SBAS is treated as an independent navigation system to calculate position based on equation (14). Thus, the receiver's position (xᵤ, yᵤ, zᵤ) and/or a clock bias tᵤᵢ of receiver relative to each navigation system (including SBAS) can be obtained.

At S12, a clock bias SBASCIkErr of a SBAS relative to each of the other navigation systems is calculated according to equation (15), by subtracting a clock bias of the receiver relative to the SBAS with a clock bias of the receiver relative to each of the other navigation systems.

Δt_{uSk}=t_{uS}−tᵤₖ (15)

wherein Δt_{uSk} represents the clock bias of the SBAS relative to the kth navigation system; t_{uS} represents the clock bias of the receiver relative to the SBAS; tᵤₖ represents the clock bias of the receiver relative to the kth navigation system. The clock bias SBASCIkErr is stored in the receiver.

Due to the characteristic of the SBAS, the clock bias SBASCIkErr of the SBAS relative to the other navigation system can vary over time. Thus, before correcting the pseudo-range according to the clock bias SBASCIkErr, the receiver needs to check the validity of the clock bias. For example, if the stored clock bias SBASCIkErr has not been updated for a time period, this clock bias is considered to have expired and cannot be used. In one embodiment, the receiver detects the quality of satellite signals of a SBAS and a navigation system at regular time intervals, and updates the clock bias SBASCIkErr when the satellite signals from both the SBAS and the navigation system have good quality.

In one embodiment, the receiver can store multiple clock biases SBASCIkErr of a SBAS relative to multiple other navigation systems.

### Embodiment 3

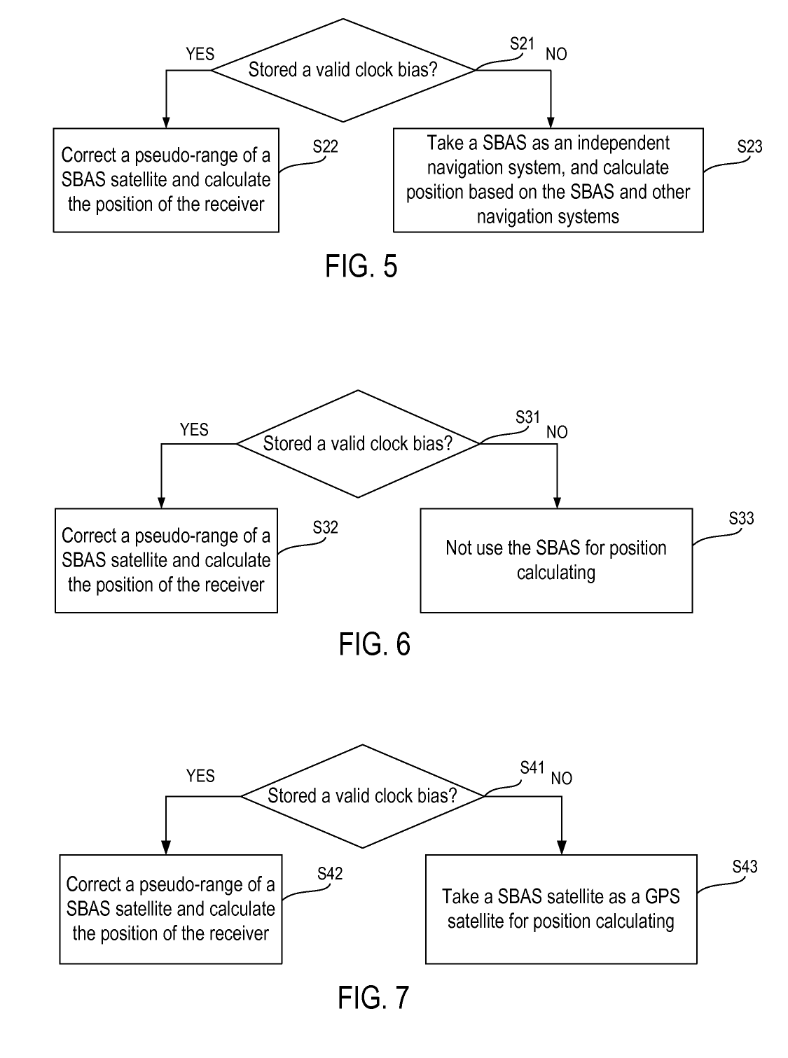

FIG. 5 shows a flowchart illustrating a method for satellite positioning, in accordance with another embodiment of the present teaching. The embodiment shown in FIG. 5 is different from the embodiment shown in FIG. 4 in that in FIG. 5, the satellite signals of a SBAS have good quality but the satellite signals of the other positioning navigation system have medium quality.

As shown in FIG. 5, this method includes following.

At S21, it is determined whether the receiver has stored a valid clock bias SBASCIkErr of a SBAS relative to the other positioning navigation system. If so, the process goes to S22; otherwise, the process goes to S23.

At S22, a pseudo-range of a SBAS satellite is corrected according to this stored clock bias SBASCIkErr, and position of the receiver is calculated using the SBAS satellite according to the corrected pseudo-range and equation (16).

ρ_{Sjd}=ρ_{Sj}−c·Δt_{uSk}=\sqrt{(x_{Sj}−xᵤ)²+(y_{Sj}−yᵤ)²+(z_{Sj}−zᵤ)²}+c·tᵤₖ (16)

wherein ρ_{Sjd} represents the corrected pseudo-range of the SBAS satellite, which is corrected as a pseudo-range of a satellite of the kth navigation system; ρ_{Sj} represents the jth satellite of the SBAS; (x_{Sj}, y_{Sj}, z_{Sj}) represents the position of jth satellite of the SBAS; Δt_{uSk} represents the clock bias SBASCIkErr of the SBAS relative to kth navigation system; tᵤₖ represents the clock bias of the receiver relative to kth navigation system; c represents the velocity of light.

The equation (16) can be derived based on the following:

For a SBAS satellite, the position can be calculated according to equation (17):

ρ_{Sj}=\sqrt{(x_{Sj}−xᵤ)²+(y_{Sj}−yᵤ)²+(z_{Sj}−zᵤ)²}+c·t_{uS} (17)

For kth navigation system, the position can be calculated according to equation (14):

ρ_{Sj}=\sqrt{(x_{Sj}−xᵤ)²+(y_{Sj}−yᵤ)²+(z_{Sj}−zᵤ)²}+c·t_{uS} (14)

The clock bias of the SBAS relative to kth navigation system can be obtained according to equation (15):

Δt_{uSk}=t_{uS}−tᵤₖ (15)

The pseudo-range of jth satellite of the SBAS can be corrected according to c·Δt_{uSk} for example, as described at the left side of the equation (16): ρ_{Sj}−c·Δt_{uSk}. And then this jth satellite can be equivalent to a satellite of kth satellite for positioning. That is, the position can be calculated according to equation (14) rather than equation (17). Thus, the equation for calculating position by using the SBAS satellite is given by equation (16):

ρ_{Sjd}=ρ_{Sj}−c·Δt_{uSk}=\sqrt{(x_{Sj}−xᵤ)²(y_{Sj}−yᵤ)²+(z_{Sj}−zᵤ)²}+c·tᵤₖ (16)

In one embodiment, there are multiple navigation systems for positioning, and there are multiple valid clock biases SBASCIkErr accordingly. The SBAS satellite can be corrected and treated as a satellite in a navigation system which has the best satellite signals quality among the other navigation systems, for calculating position according to equation (16).

At S23, a SBAS is taken as an independent navigation system, and position of the receiver is calculated based on both the SBAS and other navigation systems according to equation (14) (same as S11).

Therefore, when the satellite signals' quality of a SBAS is better than that of other navigation systems, the SBAS can be taken as one of the navigation systems for calculating position, or the corrected SBAS satellite can be taken as a satellite in other navigation systems for calculating position. This method increases the number of navigation systems and/or positioning satellites, and also improves the accuracy of positioning.

### Embodiment 4

In this embodiment, the satellite signals' quality of both a SBAS and other navigation systems is medium. The method in this embodiment may have the same process as that in Embodiment 3.

### Embodiment 5

FIG. 6 shows a flowchart illustrating a method for satellite positioning, in accordance with another embodiment of the present teaching. The embodiment in FIG. 6 is different from that in FIG. 5 in that, in FIG. 6, the satellite signals' quality of a SBAS is bad but satellite signal from one of the other positioning navigation systems has medium quality.

As shown in FIG. 6, this method includes the following.

At S31, it is determined whether the receiver has stored a valid clock bias SBASCIkErr of the SBAS relative to the other positioning navigation system. If so, the process goes to S32; otherwise, the process goes to S33.

At S32, same as S22, a pseudo-range of a SBAS satellite is corrected according to the stored clock bias SBASCIkErr, and the position is calculated using the SBAS satellite according to the corrected pseudo-range and equation (16).

At S33, the SBAS is not used for position calculating. In one embodiment, the position may be, calculated based on the other positioning navigation system alone.

### Embodiment 6

FIG. 7 shows a flowchart illustrating a method for satellite positioning, in accordance with another embodiment of the present teaching. The difference between FIG. 7 and FIG. 5 is that: in FIG. 7, the satellite signals' quality of a SBAS is good but the satellite signals' quality of one positioning navigation system is bad.

In one embodiment, this method includes the following.

At S41, it is determined whether the receiver has stored a valid clock bias SBASCIkErr of the SBAS relative to the other positioning navigation system. If so, the process goes to S42; otherwise, the process goes to S43.

At step S42, same as S22, a pseudo-range of a SBAS satellite is corrected according to the clock bias SBASCIkErr, and the position is calculated using the SBAS satellite according to the corrected pseudo-range and equation (16),

At S43, a SBAS satellite is treated as a GPS satellite for calculating position according to equation (14).

### Embodiment 7

In this embodiment, the satellite signals' quality of a SBAS is medium but the satellite signals' quality of the other navigation systems is bad. The method in this embodiment has the same processes as that in Embodiment 5.

### Embodiment 8

In this embodiment, the satellite signals' quality of both a SBAS and the other navigation systems is bad. The method in this embodiment has the same processes as that in Embodiment 6.

Furthermore, when the satellite signal's quality of a SBAS is medium or bad, but that of other navigation systems is good, the SBAS will be not used for calculating position.

In above embodiments, the receiver may estimate other navigation systems' contribution for positioning, so as to select navigation systems and satellites for positioning. The condition for estimating can include the number of satellites, the satellite signal strength, the satellite elevation, the track quality, and so on.

### Embodiment 9

In this embodiment, a SBAS and other navigation systems are used for velocity calculation according to equation (12).

The smaller a measuring error is, the smaller the DOP of the satellite distribution is, and thus the higher the accuracy of the position calculation is. Thus, it is better for the receiver to select satellites (including SBAS satellites) before positioning. Satellites can be selected based on the number of satellites, the satellite signal strength, the satellite elevation, the track quality and so on.

### Embodiment 10

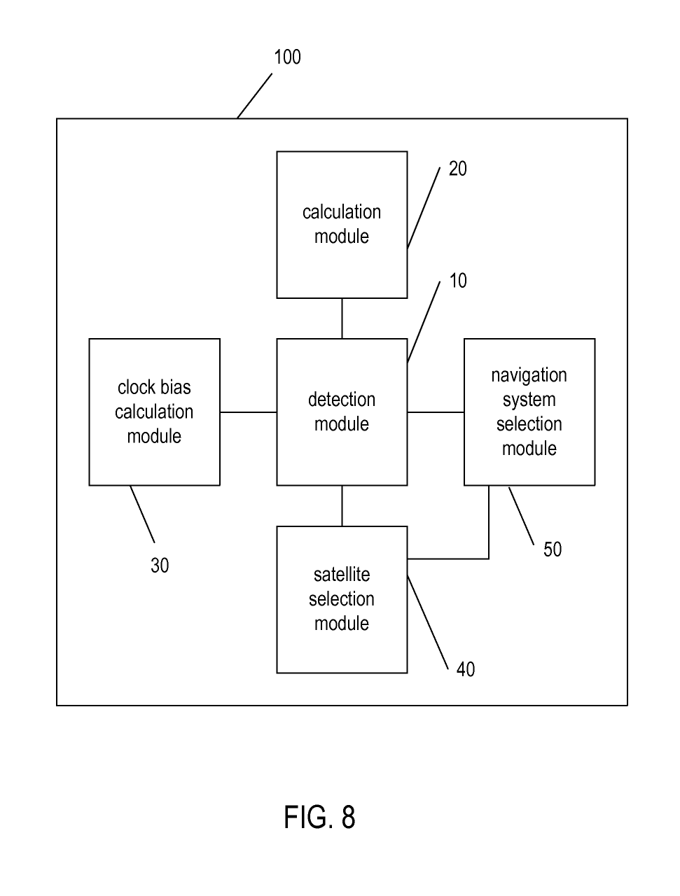

FIG. 8 shows a block diagram illustrating an example of a structure of a navigation receiver 100, in accordance with one embodiment of the present teaching. The receiver 100 includes a detection module 10 and a calculation module 20.

The detection module 10 is operable for detecting the satellite signals' quality of a SBAS and other positioning navigation systems. The calculation module 20 is coupled to the detection module 10 and operable for calculating position by combining estimated results/positions from the SBAS and other positioning navigation systems, especially when the satellite signals' quality of other positioning navigation systems is not better than that of SBAS.

Specifically, the detection module 10 is configured for determining the detected satellite signals' quality according to three levels: good, medium, and bad.

The calculation module 20 is configured for calculating the position by taking a SBAS as an independent navigation system according to equation (14) when the satellite signals' quality of the SBAS is good or medium.

ρᵢⱼ=\sqrt{(xᵢⱼ−xᵤ)²+(yᵢⱼ−yᵤ)²+(zᵢⱼ−zᵤ)²}+c·tᵤᵢ (14)

wherein ρᵢⱼ represents a pseudo-range of the jth satellite in the ith satellite navigation system; tᵤᵢ represents a clock bias of the receiver relative to ith navigation system; (xᵢⱼ,yᵢⱼ,zᵢⱼ) represents a position coordinate of the jth satellite in the ith satellite navigation system; and (xᵤ,yᵤ,zᵤ) represents a position coordinate of the receiver 100.

The calculation module 20 is configured for calculating position according to equation (16) by treating a corrected pseudo-range of a SBAS satellite as a pseudo-range of a satellite from other navigation system, when the receiver 100 has stored a clock bias of the SBAS relative to this navigation system.

ρ_{Sjd}=ρ_{Sj}−c·Δt_{uSk}=\sqrt{(x_{Sj}−xᵤ)²+(y_{Sj}−yᵤ)²+(z_{Sj}−zᵤ)²}+c·tᵤₖ (16)

wherein ρ_{Sjd} represents the corrected Pseudo-range of the SBAS satellite, which is corrected as a pseudo-range of a satellite of the kth navigation system; ρ_{Sj} represents the jth satellite of the SBAS; (x_{Sj}, y_{Sj},z_{Sj}) represents the position of jth satellite of the SBAS; Δt_{uSk} represents the clock bias SBASCIkErr of the SBAS relative to kth navigation system; tᵤₖ represents the clock bias of receiver relative to kth navigation system; and c represents the velocity of light.

The calculation module 20 is further configured for calculating position according to equation (14) by taking a SBAS satellite as a GPS satellite, when the satellite signals' quality of other positioning navigation systems is bad and the receiver 100 has not stored a clock bias of the SBAS relative to any one of navigation systems.

In one embodiment, the receiver 100 further includes: a clock bias calculation module 30, coupled to the detection module 10, configured for calculating and storing a clock bias of a SBAS relative to one navigation system according to equation (15), when the satellite signals' quality of both the SBAS and this navigation system is good.

Δt_{uSk}=t_{uS}−tᵤₖ (15)

wherein Δt_{uSk} represents the clock bias of the SEAS relative to the kth navigation system; t_{uS} represents the clock bias of receiver relative to SBAS; tᵤₖ represents the clock bias of receiver relative to the kth navigation system.

In another embodiment, the receiver 100 further includes a satellite selection module 40 and/or a navigation system selection module 50.

The satellite selection module 40 is coupled to the detection module 10, and configured for selecting positioning satellites according to at least one of the following factors: the number of satellites, the satellite signal strength, the satellite elevation, and the track quality. The navigation system selection module 50 is coupled to the detection module 10 and the satellite selection module 40, and configured for selecting positioning navigation systems according to at least one of the following factors: the number of satellites, the satellite elevation, the track quality and DOP.

While the foregoing description and drawings represent embodiments of the present disclosure, it will be understood that various additions, modifications and substitutions may be made therein without departing from the spirit and scope of the principles of the present disclosure as defined in the accompanying claims. One skilled in the art will appreciate that the disclosure may be used with many modifications of form, structure, arrangement, proportions, materials, elements, and components and otherwise, used in the practice of the disclosure, which are particularly adapted to specific environments and operative requirements without departing from the principles of the present disclosure. The presently disclosed embodiments are therefore to be considered in all respects as illustrative and not restrictive, the scope of the disclosure being indicated by the appended claims and their legal equivalents, and not limited to the foregoing description.

What is claimed is:

1. A method for satellite positioning, the method comprising:
determining first quality of a first signal associated with a Satellite Based Augmentation System (SBAS) and second quality of a second signal associated with one or more navigation systems; and
calculating a position of a receiver by combining a first estimated position from the SBAS and a second estimated position from the one or more navigation systems in a manner determined based on the first quality and the second quality.

2. The method of claim 1, wherein each of the first quality and the second quality is determined by three levels: good, medium, and bad.

3. The method of claim 2, further comprising:
calculating a clock bias of the SBAS relative to each of the one or more navigation systems according to the following equation, when both the first quality and the second quality are determined to be good:
Δt_{uSk}=t_{uS}−tᵤₖ
wherein Δt_{uSk} represents the clock bias of the SBAS relative to the kth navigation system, t_{uS} represents a clock bias of the receiver relative to the SBAS, tᵤₖ represents a clock bias of the receiver relative to the kth navigation system.

4. The method of claim 2, further comprising:
taking the SBAS as an independent navigation system to calculate position of the receiver according to the following equation, when the first quality of the first signal associated with the SBAS is good or medium,
ρᵢⱼ=\sqrt{(xᵢⱼ−xᵤ)²+(yᵢⱼ−yᵤ)²+(zᵢⱼ−zᵤ)²}+c·tᵤᵢ
wherein ρᵢⱼ represents a pseudo-range of the jth satellite in the ith satellite navigation system; tᵤᵢ represents a clock bias of the receiver relative to the ith navigation system; (xᵢⱼ,yᵢⱼ,zᵢⱼ) represents a position coordinate of the jth satellite in the ith satellite navigation system; and (xᵤ,yᵤ,zᵤ) represents a position coordinate of the receiver.

5. The method of claim 3, further comprising:
taking a corrected pseudo-range of the SBAS satellite as a pseudo-range of a satellite from one navigation system to calculate position of the receiver according to the following equation, when the receiver stores the clock bias of the SBAS relative to this navigation system.
ρ_{Sjd}=ρ_{Sj}−c·Δt_{uSk}=\sqrt{(x_{Sj}−xᵤ)²+(y_{Sj}−yᵤ)²+(z_{Sj}−zᵤ)²}+c·tᵤₖ
wherein ρ_{Sjd} represents the corrected pseudo-range of the SBAS satellite, which is corrected as a pseudo-range of a satellite of the kth navigation system, ρ_{Sj} represents the jth satellite of the SBAS, (x_{Sj},y_{Sj},z_{Sj}) represents the position of the jth satellite of the SBAS, Δt_{uS} represents the clock bias of the SBAS relative to the kth navigation system, tᵤₖ represents the clock bias of the receiver relative to the kth navigation system, c represents the velocity of light.

6. The method of claim 3, further comprising:
taking a SBAS satellite as a GPS satellite to calculate position of the receiver according to the following equation, when the second quality of the second signal associated with the one or more positioning navigation systems is bad and the receiver doesn't store the clock bias of the SBAS relative to any one of the navigation systems.
ρᵢⱼ=\sqrt{(xᵢⱼ−xᵤ)²+(yᵢⱼ−yᵤ)²+(zᵢⱼ−zᵤ)²}+c·tᵤᵢ
wherein ρᵢⱼ represents a pseudo-range of the jth satellite in the ith satellite navigation system; tᵤᵢ represents a clock bias of the receiver relative to the ith navigation system; (xᵢⱼ,yᵢⱼ,zᵢⱼ) represents a position coordinate of the jth satellite in the ith satellite navigation system; and (xᵤ,yᵤ,zᵤ) represents a position coordinate of the receiver.

7. The method of claim 1, further comprising:
selecting positioning satellites based on at least one of the following: the number of satellites, the satellite signal strength, the satellite elevation, and the track quality.

8. The method of claim 7, further comprising:
selecting positioning navigation systems based on at least one of the following: the number of satellites, the satellite elevation, the track quality and the Dilution of Precision (DOP).

9. A receiver, comprising:
a detection module, configured for determining first quality of a first signal associated with a Satellite Based Augmentation System (SBAS) and second quality of a second signal associated with one or more positioning navigation systems; and
a calculation module, configured for calculating a position of the receiver by combining a first estimated position from the SBAS and a second estimated position from the one or more positioning navigation systems in a manner determined based on the first quality and the second quality.

10. The receiver of claim 9, wherein the detection module is configured for determining each of the first quality and the second quality by three levels: good, medium, and bad.

11. The receiver of claim 9, further comprising a clock bias calculation module, wherein the clock bias calculation module is coupled to the detection module and configured for calculating a clock bias of the SBAS relative to each of the one or more navigation systems according to the following equation, when both the first quality and the second quality are determined to be good.
Δt_{uSk}=t_{uS}−tᵤₖ
wherein Δt_{uSk} represents the clock bias of the SBAS relative to the kth navigation system, t_{uS} represents a clock bias of the receiver relative to the SBAS, tᵤₖ represents a clock bias of the receiver relative to the kth navigation system.

12. The receiver of claim 10, wherein the calculation module is further configured for taking the SBAS as an independent navigation system to calculate position of the receiver according to the following equation, when the first quality of the first signal associated with the SBAS is good or medium.
ρᵢⱼ=\sqrt{(xᵢⱼ−xᵤ)²+(yᵢⱼ−yᵤ)²+(zᵢⱼ−zᵤ)²}+c·tᵤᵢ
wherein ρᵢⱼ represents a pseudo-range of the jth satellite in the ith satellite navigation system; tᵤᵢ represents a clock bias of the receiver relative to the ith navigation system; (xᵢⱼ,yᵢⱼ,zᵢⱼ) represents a position coordinate of the jth satellite in the ith satellite navigation system; and (xᵤ,yᵤ,zᵤ) represents a position coordinate of the receiver.

13. The receiver of claim 11, wherein the calculation module is further configured for taking a corrected pseudo-range of the SBAS satellite as a pseudo-range of a satellite from one navigation system to calculate position of the receiver according to the following equation, when the receiver stores the clock bias of the SBAS relative to this navigation system.
ρ_{Sjd}ρ_{Sj}−c·Δtᵤₛₖ=\sqrt{(x_{Sj}−xᵤ)²+(y_{Sj}−yᵤ)²+(z_{Sj}−zᵤ)²}+c·tᵤₖ
wherein ρ_{Sjd} represents the corrected pseudo-range of the SBAS satellite, which is corrected as a pseudo-range of a satellite of the kth navigation system, ρ_{Sj} represents the jth satellite of the SBAS, (x_{Sj},y_{Sj},z_{Sj}) represents the position of the jth satellite of the SBAS, Δt_{uSk} represents the clock bias of the SBAS relative to the kth navigation system, tᵤₖ represents the clock bias of the receiver relative to the kth navigation system, c represents the velocity of light.

14. The receiver of claim 11, wherein the calculation module is further configured for taking a SBAS satellite as a GPS satellite to calculate position of the receiver according to the following equation, when the second quality of the second signal associated with the one or more positioning navigation systems is bad and the receiver doesn't store a clock bias of the SBAS relative to any one of the navigation systems.
ρᵢⱼ=\sqrt{(xᵢⱼ−xᵤ)²+(yᵢⱼ−yᵤ)²+(zᵢⱼ−zᵤ)²}+c·tᵤᵢ
Wherein ρᵢⱼ represents a pseudo-range of the jth satellite in the ith satellite navigation system; tᵤᵢ represents a clock bias of the receiver relative to the ith navigation system; (xᵢⱼ,yᵢⱼ,zᵢⱼ) represents a position coordinate of the jth satellite in the ith satellite navigation system; and (xᵤ,yᵤ,zᵤ) represents a position coordinate of the receiver.

15. The receiver of claim 9, further comprising a satellite selection module, wherein the satellite selection module is configured for selecting positioning satellites based on at least one of the following: the number of satellites, the satellite signal strength, the satellite elevation, and the track quality.

16. The receiver of claim 15, further comprising a navigation system selection module, wherein the navigation system selection module is configured for selecting positioning navigation systems based on at least one of the following: the number of satellites, the satellite elevation, the track quality, and the Dilution of Precision (DOP).
